(19) United States
(12) Patent Application Publication
(10) Pub. No.: US 2009/0110851 A1
(43) Pub. Date: Apr. 30, 2009

(54) MELAMINE RESIN CONTAINER HAVING THREE-DIMENSIONAL SHAPE AND MANUFACTURING METHOD THEREOF

(75) Inventor: Teh-Kuan Liu, Keelung (TW)

Correspondence Address: STEVENS & SHOWALTER LLP, 7019 CORPORATE WAY, DAYTON, OH, 45459-4238, US

(73) Assignee: THUNDER GROUP INC., City of Industry, CA (US)

(21) Appl. No.: 11/951,829

(22) Filed: Dec. 6, 2007

(30) Foreign Application Priority Data
Oct. 26, 2007 (TW) 096140417

(51) Int. Cl. B29C 33/38; B29D 22/00

(52) U.S. Cl. 428/34.1; 264/220

(57) ABSTRACT

A melamine resin container having three-dimensional shape and a manufacturing method thereof. The method includes preparing a dual-mold and forming at least one predetermined pattern bulge on male die surface of the second mold; manufacturing an inner surface and using a machine to press an inner surface of the container; forming a predetermined pattern of bulge surface onto the inner/outer surface of the container; using compressing and molding and placing a color material film that corresponds respectively to the bulge surface onto the second mold, placing the accomplished bulge surface onto male die surface of the second mold and using a machine to compressing and molding the color material film onto the bulge surface to form a melamine resin container having three-dimensional shape.

### CROSS-REFERENCE TO RELATED APPLICATIONS

This non-provisional application claims priority under 35 U.S.C. § 119(a) on Patent Application No(s). 096140417 filed in Taiwan, R.O.C. on Oct. 26, 2007, the entire contents of which are hereby incorporated by reference.

### BACKGROUND OF THE INVENTION

1. Field of the Invention

The present invention relates to a melamine resin container. More particularly, the present invention relates to a melamine resin container having a three-dimensional shape and a manufacturing method thereof.

2. Related Art

Thinks to the features of high temperature resistance and impact resistance, melamine resin containers are often used for containing goods. In order to enable the melamine resin container to have a beautiful appearance, various patterns are often printed on the inner surface or the outer surface of the melamine resin container. Conventional printing method includes screen printing and transferring, and so on, which mechanically prints a predetermined pattern onto the inner surface or the outer surface or the inner/outer surface of the container, and the patterns on the surface of the melamine resin container are mostly in planar configuration. In the ROC Patent Publication No. M307361, a melamine resin container in a three-dimensional configuration is disclosed, which is formed by combining and overlapping a plurality of etched-out layers with corresponding convex layers of the etched-out layers, and different color material layers are overlapped to show different color configurations, and particularly, a multi-color and three-dimensional configuration is exhibited through stacking and sorting processes. However, the manufacturing process is difficult to be controlled, and significant defects easily occur for the products. ROC Patent Publication No. M284323 discloses another method, in which a deep color material layer having a pattern different from that of a light color material layer is overlapped and laminated on the light color material layer, to exhibit a multi-color and three-dimensional through using the difference in color and pattern. However, the manufacturing process is difficult to be controlled, and thus, the exhibition of the multi-color and three-dimensional is restricted.

### SUMMARY OF THE INVENTION

In view of the above problems, the present invention is directed to a manufacturing method of a melamine resin container having a three-dimensional shape.

In order to achieve the above objective, the present invention provides a manufacturing method of a melamine resin container having a three-dimensional shape, which includes the following steps: firstly, manufacturing a dual-mold, and forming at least one predetermined pattern bulge on a surface of a male die for a second mold; next, manufacturing an inner surface, in which the molds are assembled on a machine to perform an extrusion molding on the inner surface of the container to form a protruded surface having the predetermined pattern on the molded inner/outer surface; then, performing heat compressing and molding, in which a color material film corresponding to the protruded surface is placed on the second mold, and the accomplished protruded surface is placed on the male die of the second mold, and then heat compressing and molding are preformed through using a machine to heat compress and mold the colors of the color material film onto the protruded surface.

The present invention provides a melamine resin container having a three-dimensional shape, which includes a body having an accommodation space and a three-dimensional pattern region disposed on the body. The mold having a three-dimensional pattern is formed through laser engraving, etching, or water jet cutting, and so on.

The melamine resin container having a three-dimensional shape according to an embodiment of the present invention, the inner surface of the container has a protruded surface having a predetermined pattern thereon.

The melamine resin container having a three-dimensional shape according to an embodiment of the present invention, the outer surface of the container has a protruded surface having a predetermined pattern thereon.

The melamine resin container having a three-dimensional shape according to an embodiment of the present invention, the inner surface and the outer surface of the container respectively have a protruded surface having a predetermined pattern thereon.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a three-dimensional pattern on an inner surface of a melamine resin container according to an embodiment of the present invention;

FIG. 2A is a schematic view of a manufacturing procedure of a dual-mold of a melamine resin container according to an embodiment of the present invention;

FIG. 2B is a schematic view of a manufacturing procedure of an inner surface of a melamine resin container according to an embodiment of the present invention;

FIG. 2C is a schematic view of a manufacturing procedure of an outer surface of a melamine resin container according to an embodiment of the present invention through using a heat-compressed color material film;

FIG. 2D is a schematic view of a three-dimensional pattern on an outer surface of a melamine resin container according to an embodiment of the present invention;

FIG. 3A is a schematic view of a manufacturing procedure of a dual-mold of a melamine resin container according to an embodiment of the present invention;

FIG. 3B is a schematic view of a manufacturing procedure of an inner surface of a melamine resin container according to an embodiment of the present invention; and

FIG. 3C is a schematic view of a manufacturing procedure of an inner surface of a melamine resin container according to an embodiment of the present invention through using a heat-compressed color material film.

### DETAILED DESCRIPTION OF THE INVENTION

The detailed features and advantages of the present invention are described below in great detail, which are sufficient for those ordinarily skilled in the art to appreciate the technical content of the present invention and to make implementations accordingly. Through the content of the specification, claims and drawings in the present invention, those skilled in the art can easily understand the relevant purposes and advantages of the present invention. It is to be understood that both the foregoing general description and the following detailed description are exemplary, and are intended to provide further explanation of the invention as claimed.

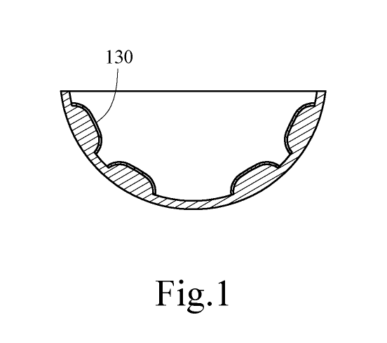

Referring to FIG. 1, it is a schematic view of a three-dimensional pattern on an inner surface of a melamine resin container according to an embodiment of the present invention.

Referring to FIG. 1, according to an embodiment of the present invention, the melamine resin container having a three-dimensional shape includes: a body having an accommodation space and a three-dimensional pattern region disposed on the body, and the mold having a three-dimensional pattern is formed through laser engraving, etching, or water jet cutting, and so on.

The laser engraving process includes, but not limited to, uploading a mold pattern to be engraved to a machine through using computer graphics software, such as Auto-CAD and Corel-Draw to engrave a mold having a three-dimensional pattern with a sealed laser engraving machine. The etching process includes, but not limited to, forming a mold having a three-dimensional pattern through reactive ion etching (RIE) method.

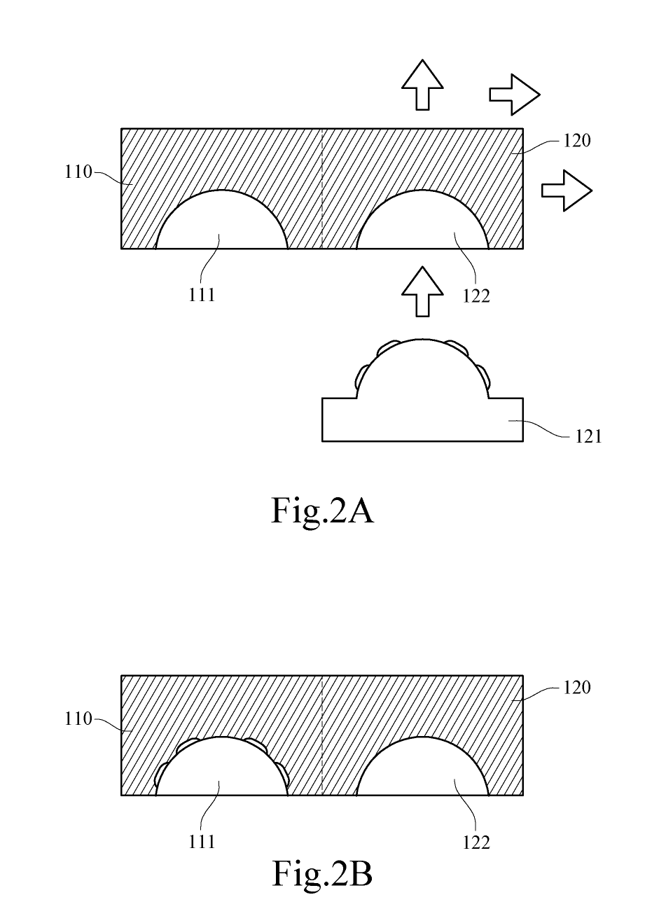

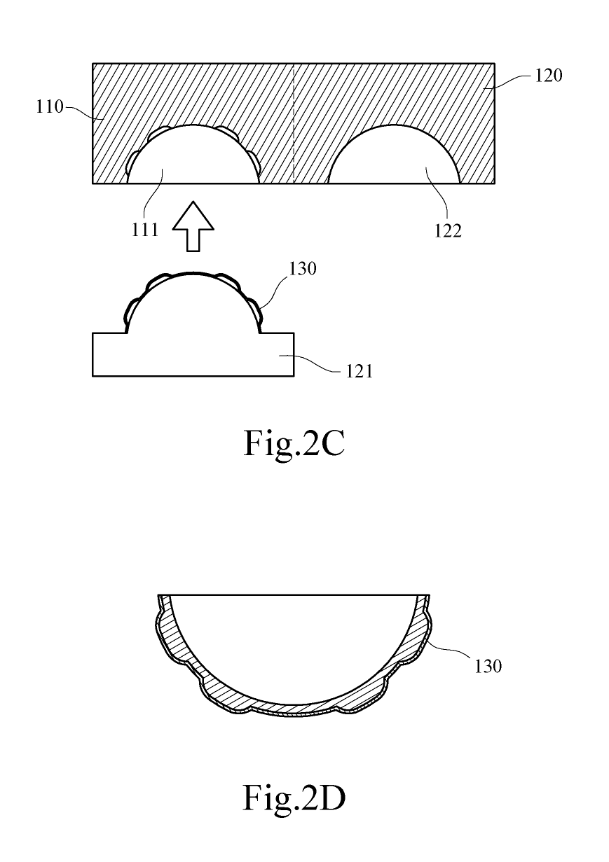

Referring to FIGS. 2A to 2C, they are schematic views of a manufacturing method of a melamine resin container having a three-dimensional shape according to an embodiment of the present invention.

Referring to FIGS. 2A to 2C, the manufacturing method according to an embodiment of the present invention includes the following steps. Firstly, a dual-mold including a first mold 110 and a second mold 120 is manufactured, in which the cavity space of the male die and the female die 111 for the first mold is a half of the thickness of the product, the size of the male die 121 for the second mold is the same as that of the product, and the size of the female die 122 for the second mold is the same as that of the female die 111 for the first mold. Next, at least one predetermined pattern bulge is formed on the surface of the male die 121 for the second mold, such that when performing an extrusion molding on the second mold 120 through using a machine, a protruded surface having the predetermined pattern is formed on the outer surface thereof. Then, an inner surface is manufactured, in which the first mold 110 and the second mold 120 are assembled on a machine to perform an extrusion molding on the inner surface of the container to form a protruded surface having the predetermined pattern on the molded outer surface. Then, a heat compressing and molding is performed, in which a color material film 130 corresponding to the protruded surface is placed on the male die 121 of the second mold, and the color material film 130 has the same or different color materials, then the accomplished protruded surface is placed on the second mold 120, and then heat compressing is performed to the color material film 130 on the male die 121 of the second mold through using the machine to mold the color of the color material film 130 onto the protruded surface.

The manufacturing method of the dual-mold may be selected from open-die forging or close-die forging.

Referring to FIG. 2D, it is a schematic view of a three-dimensional pattern on an outer surface of a melamine resin container according to another embodiment of the present invention.

Referring to FIG. 2D, according to another embodiment of the present invention, a melamine resin container having a three-dimensional shape includes: a body having an accommodation space and a three-dimensional pattern region disposed on the body, and the mold having the three-dimensional pattern is formed through laser engraving, etching, or water jet cutting, and so on.

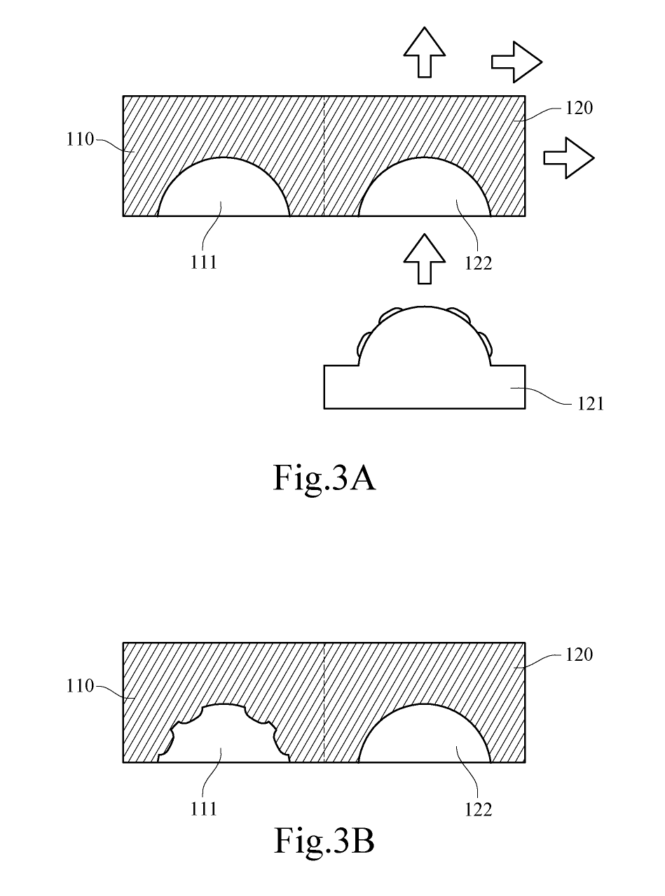

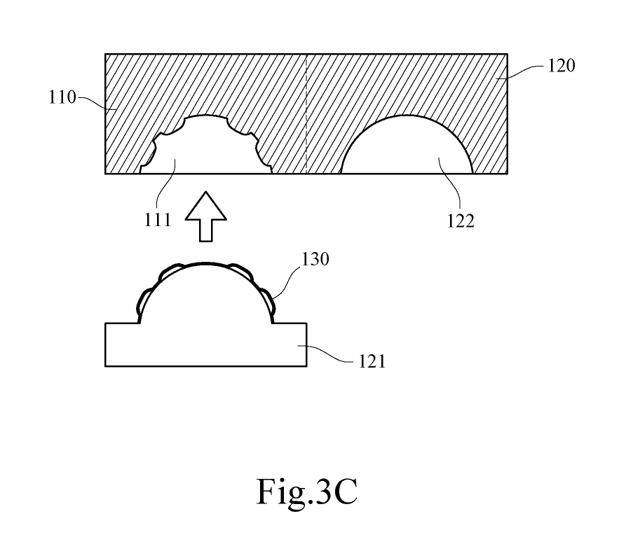

Referring to FIGS. 3A to 3C, they are schematic views of a manufacturing method of a melamine resin container having a three-dimensional shape according to another embodiment of the present invention.

Referring to FIGS. 3A to 3C, the manufacturing method according to another embodiment of the present invention includes the following steps. Firstly, a dual-mold including a first mold 110 and a second mold 120 is manufactured, in which the cavity space of the male die and the female die 111 for the first mold is a half of the thickness of the product, the male die 121 of the second mold is the same as the protruded surface having the predetermined pattern, and the size of the female die 122 for the second mold is the same as that of the product. Particularly, at least one predetermined pattern bulge is formed on the surface of the male die 121 for the second mold, such that when performing an extrusion molding on the second mold 120 through using a machine, a protruded surface having the predetermined pattern is formed on the inner surface. Then, an inner surface is manufactured, in which the first mold 110 and the second mold 120 are assembled on the machine to perform an extrusion molding on the inner surface of the container to form a protruded surface having the predetermined pattern on the molded inner surface. Then, a heat compressing and molding is performed, in which a color material film 130 corresponding to the protruded surface is placed on the male die 121 of the second mold, in which the color material film 130 has the same or different color materials, then the accomplished protruded surface is placed on the second mold 120, and then heat compressing is performed to the color material film 130 on the male die 121 of the second mold through using the machine to mold the color of the color material film 130 onto the protruded surface.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A manufacturing method of a melamine resin container having a three-dimensional shape, comprising:
manufacturing a dual-mold, wherein the dual-mold has a first mold and a second mold, at least one predetermined pattern bulge is formed on a surface of a male die for the second mold, such that when performing an extrusion molding on the second mold through using a machine, a protruded surface having a predetermined pattern is formed on an outer surface thereof;
manufacturing an inner surface, wherein the first and second molds are assembled on the machine to perform an extrusion molding on the inner surface of the container to form a protruded surface having a predetermined pattern on the molded outer surface; and
performing heat compressing and molding, wherein a color material film corresponding to the protruded surface is placed on the male die of the second mold, and the accomplished protruded surface is placed on the male die of the second mold, and heat compressing is performed to the color material film on the male die of the second mold through using the machine to mold the color of the color material film onto the protruded surface.

2. The manufacturing method of the melamine resin container as claimed in claim 1, wherein a cavity space of male and female dies for the first mold is a half of the thickness of the product.

3. The manufacturing method of the melamine resin container as claimed in claim 1, wherein the size of the male die for the second mold is the same as that of the product, and the size of the female die for the second mold is the same as that of the female die for the first mold.

4. The manufacturing method of the melamine resin container as claimed in claim 1, wherein the color material film provides the same color material.

5. The manufacturing method of the melamine resin container as claimed in claim 1, wherein the color material film provides different color materials.

6. A manufacturing method of a melamine resin container having a three-dimensional shape, comprising:
manufacturing a dual-mold, wherein the dual-mold has a first mold and a second mold, at least one predetermined pattern bulge is formed on a surface of a male die for the second mold, such that when performing an extrusion molding on the second mold through using a machine, a protruded surface having a predetermined pattern is formed on an inner surface thereof;
manufacturing an inner surface, wherein the first and second molds are assembled on the machine to perform an extrusion molding on the inner surface of the container to form a protruded surface having the predetermined pattern on the molded inner surface; and
performing heat compressing and molding, wherein a color material film corresponding to the protruded surface is placed on the male die of the second mold, and the accomplished protruded surface is placed on the male die of the second mold, and heat compressing is performed to the color material film on the male die for the second mold through using the machine to mold the color of the color material film onto the protruded surface.

7. The manufacturing method of the melamine resin container as claimed in claim 6, wherein a cavity space of male and female dies for the first mold is a half of the thickness of the product.

8. The manufacturing method of the melamine resin container as claimed in claim 6, wherein the male die of the second mold is the same as the protruded surface having the predetermined pattern, and the size of the female die for the second mold is the same as that of the product.

9. The manufacturing method of the melamine resin container as claimed in claim 6, wherein the color material film provides the same color material.

10. The manufacturing method of the melamine resin container as claimed in claim 6, wherein the color material film provides different color materials.

11. A melamine resin container having a three-dimensional shape, comprising:
a body, having an accommodation space; and
a three-dimensional pattern region, disposed on the body.

12. The melamine resin container having the three-dimensional shape as claimed in claim 11, wherein the three-dimensional pattern is disposed on an inner surface of the body.

13. The melamine resin container having the three-dimensional shape as claimed in claim 11, wherein the three-dimensional pattern is disposed on an outer surface of the body.

14. The melamine resin container having the three-dimensional shape as claimed in claim 11, wherein the three-dimensional pattern is respectively disposed on the inner surface and the outer surface of the body.

15. The melamine resin container having the three-dimensional shape as claimed in claim 11, wherein the mold having the three-dimensional pattern is formed through laser engraving.

16. The melamine resin container having the three-dimensional shape as claimed in claim 11, wherein the mold having the three-dimensional pattern is formed through etching.

17. The melamine resin container having the three-dimensional shape as claimed in claim 11, wherein the mold having the three-dimensional pattern is formed through water jet cutting.
